(19) United States
(12) Patent Application Publication
(10) Pub. No.: US 2022/0055008 A1
(43) Pub. Date: Feb. 24, 2022

(54) FLOW-TYPE REACTOR HEAT-EXCHANGER AND METHODS OF MANUFACTURE THEREOF

(71) Applicant: The Johns Hopkins University, Baltimore, MD (US)

(72) Inventor: Jonathan P. Jones, Hanover, MD (US)

(21) Appl. No.: 17/336,489

(22) Filed: Jun. 2, 2021

Related U.S. Application Data
(60) Provisional application No. 63/066,870, filed on Aug. 18, 2020.

(51) Int. Cl. B01J 19/00; B01J 19/12; B01J 19/24

(52) U.S. Cl. CPC B01J 19/0013; B01J 19/126; B01J 19/123; B01J 19/128; B01J 19/125; B01J 2219/2416; B01J 2219/00054; B01J 2219/00087; B01J 2219/00141; B01J 2219/00146; B01J 19/2415

(57) ABSTRACT

A reactor includes a first outer tube configured to contain a working fluid, and a first inner tube disposed in the first outer tube. The first inner tube is configured to contain a source of heat to transfer or absorb heat to or from the working fluid. The reactor further includes a second inner tube in the first outer tube. The second inner tube is wound around the first inner tube in a helical fashion, and the second inner tube is configured absorbs heat from and/or dissipates heat to the working fluid, and/or facilitate a reaction in a reactant contained in the second inner tube.

### CROSS-REFERENCE TO RELATED APPLICATIONS

This application claims priority to and the benefit of prior-filed, co-pending U.S. Provisional Application Ser. No. 63/066,870 filed on Aug. 18, 2020, the entire content and disclosure of which is hereby incorporated herein by reference.

### STATEMENT OF GOVERNMENTAL INTEREST

This invention was made with government support under contract number HR00111620029 awarded by the Defense Advanced Research Projects Agency (DARPA). The government has certain rights in the invention.

### BACKGROUND

This disclosure relates to a flow-type reactor heat-exchanger and to methods of manufacture and use thereof.

Heat exchangers are devices that are used to transfer thermal energy from one fluid to another without necessarily mixing the two fluids. The fluids are usually separated by a solid wall (with high thermal conductivity) to prevent mixing. Heat transfer in such a heat exchanger usually involves convection in each fluid and thermal conduction through the wall separating the two fluids.

Heat exchangers are classified according to flow arrangement and type of construction. The simplest heat exchanger is one in which the hot and cold fluids move in the same direction (parallel-flow arrangement) or in opposite directions (counter-flow arrangement). The heat exchanger typically includes two concentric pipes of different diameters.

In the parallel-flow arrangement, the hot and cold fluids enter at the same end, flow in the same direction, and leave at the same end.

In the counter-flow arrangement, the fluids enter at opposite ends, flow in opposite directions, and leave at opposite ends.

Under comparable conditions, more heat is transferred in a counter-flow arrangement than in a parallel flow heat exchanger.

There are several significant drawbacks to these types of heat exchangers; for example, the large temperature difference at the ends causes large thermal stresses. Additionally, the temperature of the cooler fluid exiting the heat exchanger never exceeds the lowest temperature of the warmer fluid.

There is therefore a need and desire for heat exchangers that do not suffer from these drawbacks.

### SUMMARY

According to one non-limiting, example embodiment, a reactor includes a first outer tube configured to contain a working fluid, and a first inner tube disposed in the first outer tube. The first inner tube is configured to contain a source of heat to transfer or absorb heat to or from the working fluid. The reactor further includes a second inner tube in the first outer tube. The second inner tube is wound around the first inner tube in a helical fashion, and the second inner tube is configured absorbs heat from and/or dissipates heat to the working fluid, and/or facilitate a reaction in a reactant contained in the second inner tube.

According to another non-limiting, example embodiment, method of manufacturing a reactor includes disposing a first inner tube in a first outer tube, with the first outer tube being configured to contain a working fluid. The method further includes disposing a second inner tube in the first outer tube. The second inner tube is wound around the first inner tube in a helical fashion, and the second inner tube is configured to absorb heat from or dissipate heat to the working fluid and/or to facilitate a reaction in a reactant disposed in the second inner tube.

According to yet another non-limiting, example embodiment, a method of using a reactor includes using a reactor includes charging a working fluid to the reactor, absorbing heat from the working fluid or dissipating heat to the working fluid, and/or facilitating a reaction in a reactant disposed in the second inner tube. The reactor includes a first outer tube configured to contain the working fluid, and a first inner tube disposed in the first outer tube. The first inner tube includes a source of heat to transfer heat to the working fluid and/or absorb heat from the working fluid. A second inner tube is wound around the first inner tube in a helical fashion within the first outer tube.

### BRIEF DESCRIPTION OF THE DRAWINGS

The above and other features and advantages will become more readily apparent from the detailed description of several non-limiting, example embodiments, accompanied by the drawings, in which:

FIG. 1 is a schematic depiction of one example embodiment of a reactor;

FIG. 2 is another schematic depiction of another example embodiment of a reactor;

FIG. 3 is yet another schematic depiction of another example embodiment of a reactor; and

FIG. 4 is still another schematic depiction of another example embodiment of a reactor.

### DETAILED DESCRIPTION

Disclosed herein is a reactor/heat-exchanger (referred to herein as a “reactor”) that includes a first inner tube, a first outer tube that surrounds the first inner tube and a second inner tube that lies between the first inner tube and the first outer tube. The first inner tube shares a common longitudinal axis with the first outer tube (i.e., the first inner tube and the first outer tube are concentrically mounted) while a longitudinal axis of the second inner tube traces a helical path around the common longitudinal axis (of the first inner tube and the first outer tube). In an embodiment the second inner tube contains reactants (e.g., fluids) for a reaction and the temperature (as well as other characteristics) of the fluid in the region between the first inner tube and the first outer tube may be selected to facilitate a reaction between reactants.

In an embodiment, the first outer tube may be insulated to prevent heat losses. There may also be a plurality of second inner tubes located between the first inner tube and the first outer tube. Thus use of a plurality of second inner tubes can improve productivity of the device while at the same time prevent reactant losses due to heat transfer or mass transfer that typically occur in large reactors. In an embodiment, one or more of the first inner tube, the first outer tube or the second inner tube may be provided with a facility for generating one or more frequencies in the electromagnetic spectrum (during manufacturing operations) thus providing an additional means for facilitating reactions between the reactants. Details of all of these features will be provided later in this disclosure.

This design has a large number of advantages over conventional reactors in that the second inner tube may be pressurized to the pressure-limits of the first inner tube and the first outer tube. This design allows the second inner tube to be pressurized to pressures beyond the normal yield-limit of the tubing and up to the rupture limit of material used in the first inner tube and the first outer tube. This can be conducted without any substantial dimensional changes in the second inner tube during an operation. Therefore, high-pressure reactions can occur without the need for specialized glass-lined metal reactors, which are both expensive and fragile. The dimensions of the entire reactor can be easily changed (if desired) prior to conducting reactions. This is discussed in detail later.

The ability to conduct high pressure reactions is advantageous because of typical pressure limitations of polymer flow-type reactors. Typical polymer flow-type reactors cannot withstand high pressure and high heat whereas this reactor changes the pressure limit of a polymer flow-type reactor (the second inner tube) to that of the rupture limit of the first outer tube.

Most conventional reactors can handle either a) relatively few types of reactants at a wide range of conditions or b) many types of reactants at a very small range of conditions. The reactor disclosed herein can handle both situations without any complications. Membrane reactors are not implemented as often as they could be, partially due to the difficulties associated with constructing a tube-in-tube reactor system. This design provides a simple, flexible framework to implement membrane reactors that can meet stringent pressure and temperature requirements. Many flow-type chemistry/chemical systems have a low pressure-limit due to the pressure limit of the tubing for handling high-concentration, harsh chemicals. The disclosed reactor rectifies these issues by allowing the use of an inert, pressurized fluid to distribute the pressure to a metal enclosure.

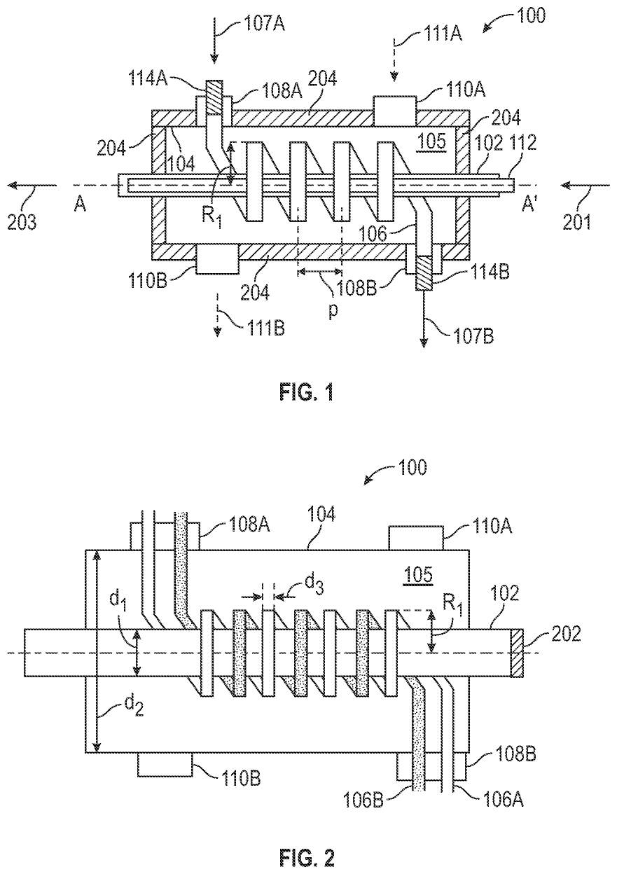

FIG. 1 is a schematic diagram that depicts a reactor 100 that includes a first inner tube 102, an outer tube 104, e.g., a first outer tube 104, and a second inner tube 106. The first inner tube 102 has a longitudinal axis AA′ that is parallel (i.e. along a same direction as viewed in FIG. 1) to a longitudinal axis of the first outer tube 104. In an embodiment, the first inner tube 102 has the longitudinal axis AA′ that is concentric with respect to the longitudinal axis of the first outer tube 104. The first inner tube 102 has a diameter (specifically, an inner diameter) d₁ (FIG. 2) that is smaller than a diameter (i.e. an inner diameter) d₂ (FIG. 2) of the first outer tube 104. In one embodiment, a ratio of the diameters d₁ and d₂ of the first inner tube 102 and the first outer tube 104, respectively, is from about 0.1 to about 0.9. As shown in FIG. 1, the second inner tube 106 winds helically around the longitudinal axis AA′ of the first inner tube 102. More specifically, the second inner tube 106 is wound around the first inner tube 102 and, in one example embodiment, continuously contacts the first inner tube 102. In another embodiment, the second inner tube 106 is wound around the first inner tube 102, but does not continuously contact the first inner tube 102 (e.g., there are gaps between portions of the first inner tube 102 and the second inner tube 106). In yet another embodiment, the second inner tube 106 is wound around the first inner tube 102 but does not contact the first inner tube 102 at all (e.g., there is a gap between the first inner tube 102 and the second inner tube 106).

In an embodiment, the ratio of the diameters d₁ and d₂ is set by a bend radius R₁ of the second inner tube 106. In this case, the diameter d₂ of the first outer tube 104 is large enough to accommodate the bend radius R₁ of the second inner tube 106, as shown in FIGS. 1 and 2. A maximum value of the diameter d₁ of first inner tube 102 is then less than the diameter d₂ of the first outer tube 104 minus two times a diameter d₃ of the second inner tube 106.

While the reactor 100 shown in FIG. 1 includes a single, linear first inner tube 102, the first inner tube 102 can travel back and forth in the outer tube. There can also be a plurality of the inner tubes 102 contained in the reactor 100, each inner tube 102 of the plurality of inner tubes being wrapped with one or more second inner tubes 106. These embodiments will be described in further detail below.

In an embodiment, the reactor 100 can have three fluids simultaneously flowing through the tubes therein. In one embodiment, at least two of the fluids may be the same fluid or type of fluid (and in one embodiment they may be identical fluids or identical types of fluids), while the third fluid (the fluid being transported through the second inner tube 106, for example) is different (i.e. is a separate, different fluid and/or not the same type of fluid) from the fluids being transported in the first inner tube 102 and the first outer tube 104. For example, the fluid flowing through the first inner tube 102 can be the same or different from the fluid being transported through the first outer tube 104.

In another embodiment, the fluids being transported through the respective tubes 102, 104, and 106 can all be different from one another. The fluids can all be transported in the same general direction (parallel flow) or alternatively, at least one fluid can be transported in a direction different from (in some cases, opposite to) the flow direction of another fluid (counter flow). In one embodiment, two fluids can be transported in one direction while another fluid can be transported in a different or opposite direction (to the other two fluids).

Still referring to FIG. 1, the first inner tube 102 may be used to heat and/or cool a fluid (hereinafter a working fluid) contained in a space 105 of the first outer tube 104. The first inner tube 102 may heat the working fluid in the space 105 using conduction, convection, or radiation, for example, though alternative embodiments are not limited thereto. In one embodiment, for example, the working fluid contained in the space 105 may be heated via convection by heat supplied from the first inner tube 102. The working fluid contained in the space 105 may thus be indirectly used to heat and/or cool reactants (e.g., fluids) contained in the second inner tube 106.

In one embodiment, the heat supplied by the first inner tube 102 may also be used to heat the reactants contained in the second inner tube 106 by direct conduction resulting from contact of the first inner tube 104 to the second inner tube 106. Thus, the reactants contained in the second inner tube 106 may be heated indirectly via convection or directly via conduction from the heat supplied by the first inner tube 102. The first inner tube 102 may be used to supply (or remove) heat to the working fluid in the space 105 as well as to the second inner tube 106 in a variety of different ways, which are described below.

A source of heat 112 may be used in the first inner tube 102 to heat and/or cool the working fluid (in the space 105) as well as the reactants contained in the second inner tube 106. In an embodiment, the source of heat 112 may be contained in the first inner tube 102 and may include a heating coil (not shown) or a cartridge 112 (e.g., a heating cartridge 112) that is electrically heated (ohmic heating) to promote heating of the working fluid in the space 105. The working fluid in the space 105 can thus heat reactants contained in the second inner tube 106. The cartridge 112 may extend the entire length of the inner tube 102 or may extend for only a portion of the length of the inner tube 102. The cartridge 112 can be inserted and extracted from the first inner tube 102 when desired. In other words, the cartridge 112 is removable and replaceable either with another cartridge 112 or with another source of heat 112 (that uses other modes of heating or cooling, as desired). Heat provided by the cartridge 112 may also be used to directly transmit heat (via conduction) from the first inner tube 102 to the second inner tube 106.

In another embodiment, the first inner tube 102 may be heated inductively. Induction heating is a process of heating an electrically conducting object (usually a metal) by electromagnetic induction, through heat generated in the object by current induced within the object through the application of electromagnetic energy to the object. Specifically, a typical in induction heater includes an electromagnet and an electronic oscillator that passes a high-frequency alternating current (AC) through the electromagnet. The rapidly alternating magnetic field penetrates the object, generating electric currents (called eddy currents), inside the conductor. The eddy currents flowing through the material heat the material by resistive (Joule or Ohmic) heating.

In an embodiment implementing inductive heating, the first inner tube 102 is manufactured from a ferromagnetic or magnetic material (e.g., iron, steel, and the like) while a coil (not shown) having a smaller diameter than the diameter d₁ of the first inner tube 102 is oscillated into and out of the first inner tube 102. The coil is activated with a high-frequency alternating current causing eddy currents to flow in the first inner tube 102. Heat is thereby generated in the inner tube 102.

In ferromagnetic (and ferrimagnetic) materials like iron, heat may also be generated by magnetic hysteresis losses. The frequency of current used to generate hysteresis losses depends on the object size, material type, coupling (between the work coil and the object to be heated), and the penetration depth. The frequency of current may thus be used to control an amount of heat generated in the first inner tube 102.

In an embodiment shown in FIG. 2, the first inner tube 102, the first outer tube 104 and/or the second inner tube (or tubes) 106 may be fitted with or contacted with a source of electromagnetic radiation 202, such as a magnetron (for generating microwaves), a radio-frequency generator, an ultraviolet (UV) light (for generating UV light), an infrared wave generator (for generating infrared waves), an x-ray tube (for generating x-rays), an electron beam generator (for generating electron radiation), and so on. The reactor 100 may also be in communication with a cyclotron (not shown), if desired. In FIG. 2, one end of the first inner tube 102 is fitted with the source of electromagnetic radiation 202. The source of electromagnetic radiation 202 may be used to facilitate heating of the fluids, reactants, products, and/or solvents in the second inner tube 106, the working fluid in the space 105 and/or a fluid in the first inner tube 102. In another embodiment, the source of electromagnetic radiation 202 may be used to facilitate reactions in the second inner tube 106.

For short-wave radiation, the first inner tube 102 may be used to transmit radiation from a radiating core (e.g. a plasma such as from a mercury lamp, a halide gas, or a band-gap emitters [semiconductors]). The material used to manufacture the first inner tube 102 can be varied depending upon the type of electromagnetic radiation to be transmitted through the first inner tube 102. The type of radiation will determine a cross-sectional geometry of the first inner tube 102. For example, a circular cross-section will accommodate most types of radiation, but alternative example embodiments are not limited thereto. In one embodiment, the material used for the construction of the second inner tube 106 is selected so as to not shield the reactants from the radiation.

When the source of electromagnetic radiation 202 is a magnetron, the fluids in one or more of the tubes 102, 104, and/or 106 may be heated using microwaves. In this case, one or more of the tubes 102, 104, and/or 106 function as waveguides. When the source of electromagnetic radiation 202 is ultraviolet light, the reactants in the second inner tube 106 may be reacted using photons. Depending upon the source of electromagnetic radiation, appropriate shielding may be provided to the reactor 100 to prevent damage to surrounding personnel, equipment, and environment. The source of electromagnetic radiation 202 can be fixed or be removable (to be replaced with another source of energy such as the cartridge 112 shown in FIG. 1 or a heating/cooling fluid source, for example).

In another embodiment, the first inner tube 102 can be supplied with a first fluid that may be used to heat and/or cool a fluid contained in the space 105 of the first outer tube 104. As noted above, the first inner tube 102 can provide heat to reactants indirectly via convection, or directly via conduction. The first fluid is typically heated outside the reactor 100 and is charged to the first inner tube 102 via a pump (not shown). A flow direction of the first fluid can be parallel to, or counter to, a flow of a second fluid contained in the space 105. For example, the flow of the first fluid can be parallel to or counter to the flow of reactants contained in the second inner tube 106. Fluid flow in the first inner tube 102 is shown in FIG. 1 by arrows 201 and 203.

In all of the foregoing instances of heating of the inner tube 102, a thermocouple (not shown) with appropriate controlling equipment is used to control the amount of heating or cooling provided to the first inner tube 102 and thus to the reactants contained in the second inner tube 106.

In another example embodiment, the cartridge 112 (FIG. 1) may be replaced with a fluid line (not shown) through which heating/cooling fluid can be used to heat or cool the reactants in the second inner tube 106. In a similar manner, the cartridge 112 may be replaced by a coil (not shown) that produces inductive heating. The various heating and cooling accessories are therefore removable and replaceable when desired. This design is advantageous in that it couples the benefit of the simplicity of using solely a cartridge 112 or an induction coil with the benefit of being able to use extreme temperature-fluids (e.g. liquid helium, liquid nitrogen, liquid carbon dioxide for cold fluids and low-temperature plasma [e.g., low temperature flame] for high-temperature fluids) for heating the working fluid in the space 105 and hence the reactants in the second inner tube 106.

In an embodiment, pressure transducers (not shown) with appropriate controlling equipment may be used to ensure that a pressure difference across the walls of the second inner tube 106 (as determined by the pressure in the space 105 and the pressure of reactants inside the tube first inner tube 102) stays within pre-determined limits. If a liquid fluid (e.g. liquid water) is used to fill the space 105, then pressure control may not be needed such a liquid is essentially incompressible.

The pressure transducers may be absolute (one located in each of the tubes), differential, or a combination thereof. One aspect of pressure control is simultaneously controlling the pressure difference across the second inner tube 106 and the total pressure in the first outer tube 104.

The first inner tube 102 may be manufactured from a metal, a ceramic, a polymer, or a combination thereof. In one example embodiment, the first inner tube 102 includes a metal or a ceramic. The metals and ceramics used in the construction of the first inner tube 102 can withstand the temperatures and pressures that the reactor 100 will be subjected to. The metals and ceramics will also withstand chemical attack from the fluids and reactants used therein. Suitable metals include iron, carbon steel, stainless steel, aluminum, titanium, nickel, molybdenum, or the like, or a combination thereof. The metals may be glass lined if desired. Suitable ceramics include glass, quartz, silicon carbide, siliconized silicon carbide, or the like, or a combination thereof. Suitable polymers include polyolefins, polyfluoroethylenes, polyimides, polyetherimides, polyether ether ketones, polyimide-polysiloxane copolymers, polysiloxanes, or the like, or a combination thereof.

The first inner tube 102 may be fitted into the first outer tube 104 using modular bored-through reducers and/or bulk-heads (neither shown) to seal the first inner tube 102 within the first outer tube 104 and prevent any leakage of the working fluid from the space 105.

The reactor 100 (or portions thereof) may be assembled using modular manufactured components. Modular manufacturing is a process of producing individual sections, or modules, that may be assembled into a reactor 100 on site. The individual sections or modules are manufactured to be interchangeable and can be replaced rapidly.

In an embodiment, a size of the reactor 100 may be changed rapidly, thus providing for varied reaction capabilities depending upon manufacturing demand and conditions. For example, a first inner tube 102 of a particular length and diameter may be replaced with a first inner tube 102 of a different length and diameter. Similarly, the length, diameter, and pitch of the second inner tube 106 may be quickly changed by replacing one tube with another of different dimensions. This can be done with the first outer tube 104 as well. These changes can be made rapidly between production runs thus providing the manufacturer with manufacturing flexibility.

The first inner tube 102 may be used to vary a temperature of fluid/reactants in the second inner tube 106 from temperatures of about −260 degrees Celsius (° C.) to about 500° C., or, in an alternative embodiment, from about −150° C. to about 400° C., based on desired conditions and materials used.

The first outer tube 104 has the diameter d₂ that is greater than the diameter d₁ of the first inner tube 102. In an alternative example embodiment, the first outer tube 104 can include one or more of the first inner tubes 102, upon which are mounted one or more second inner tubes 106, as will be described in greater detail with references to FIGS. 1-4. In this case, the first outer tube 104 is fitted with an inlet port 110A (or a plurality thereof) and an outlet port 110B (or a plurality thereof), which respectively accommodate the ingress and egress of the working fluid (in the space 105), as well as provide for the entry and exit of the second inner tube(s) 106 into and out of the first outer tube 104. Specifically, the working fluid is charged into the first outer tube 104 via the inlet port 110A and is discharged from the first outer tube 104 via the outlet port 110B. Arrow 111A (FIG. 1) represents the working fluid at the inlet port 110A while arrow 111B (FIG. 1) represents the working fluid at the outlet port 110B. Each inlet port 110A and/or outlet port 110B may be fitted with a valve (not shown), a pump (not shown), and/or associated control equipment (not shown) to facilitate temperature and pressure control of the working fluid in the space 105.

The working fluid is a pressurization fluid that distributes pressure inside the first outer tube 104 (in the space 105) thereby allowing the second inner tube 106 to withstand internal pressures up to a failure strength (e.g., a rupture strength) of the first outer tube 104.

The working fluid may be any fluid that will not react with or adversely affect the materials of construction of the inner and outer tubes 102, 104, 106. The working fluid is also capable of handling the temperatures and pressures desired for conducting reactions in the second inner tube 106 without undergoing degradation. The working fluid can be used to cool the second inner tube 106 (e.g., to temperatures down to or below about —260° C.) or heat the second inner tube 106 if so desired (e.g., to temperatures up and above about 500° C.). The working fluid is capable of withstanding temperatures of greater than 200° C., or in an alternative embodiment, greater than 300° C., and pressures greater than 25 kilograms per square centimeter (kg/cm²), or in an alternative embodiment, greater than 50 kg/cm². In an embodiment, the working fluid can withstand temperatures of up to 500° C. and pressures of up to 2000 kg/cm².

The working fluid may be used cold such as, for example, liquified gases such as carbon dioxide, nitrogen, helium, oxygen, or the like, or a combination thereof. Slurries of solid gases (e.g., dry ice) with solvents such as alcohol, water, or the like, may also be used as the working fluid. In another embodiment, the working fluid may be used at an elevated temperature. Working fluids that can function at elevated temperatures include hydrocarbon oils, triethylene glycol, propylene glycol, ethylene glycol, molten salts, alcohols, silicone oils, calcium salts in brine, or the like, or a combination thereof.

In one embodiment, the working fluid is a carrier sweep-fluid that is used to facilitate diffusion of reaction products from the inside of the second inner tube 106 to outside of the second inner tube 106. In this event, the second inner tube 106 functions as an osmotic membrane (that is permeable or semi-permeable) to separate retentate from permeate thus driving the reaction to one hundred percent conversion. Likewise, via diffusion, the working fluid can deliver reactants to the second inner tube 106. This is described in detail later.

In one embodiment, the working fluid may be a boiling fluid instead of a pressurization fluid. In other words, by using a working fluid and/or a process fluid at its boiling point in the reactor 100, the reactants in the second inner tube 106 can be subjected to very specific temperature conditions during the reaction. This would set a highly-specific temperature for the reactor based off of the boiling point of that fluid. The reactor design thus permits the use of very specific temperature conditions for heating or cooling reactants in the second inner tube 106. This cannot be accomplished in conventional reactors where thermostats can only control temperature conditions in a range that is dependent upon the thermostat sensitivity, the size of the reactors, and the like.

The first outer tube 104 is also fitted with an inlet port 108A, different from the inlet port 110A, and an outlet port 108B, different from the outlet port 110B, for permitting the second inner tube 106 to enter and exit the first outer tube 104. Arrow 107A (FIG. 1) represents fluid/reactant entering the inlet port 108A while arrow 107B (FIG. 1) represents the fluid/reactant at the outlet port 108B. The inlet port 108A and the outlet port 108B may be fitted with modular bored-through reducers and/or bulk-heads (neither shown) to seal the second inner tube 106 within the first outer tube 104 and prevent any leakages of the working fluid from the space 105.

In an embodiment, the inlet port 108A and the outlet port 108B at which the second inner tube 106 enters and exits the first outer tube 104 are respectively fitted with interface tubes 114A and 114B (FIG. 1). The interface tubes 114A and 114B prevent sections of the second inner tube 106 that lie outside the first outer tube 104 from rupturing due to the pressure on the reactants inside the second inner tube 106. The interface tubes 114A and 114B isolate the second inner tube 106 from pressure conditions outside of the first outer tube 104.

In an embodiment, the interface tubes 114A and 114B includes corrosion resistant, high-pressure tubing, which is provided with the fittings such that swapping out reactor tubing may be conducted swiftly and efficiently. In an embodiment, the interface tubes 114A and 114B includes bored-through compression fittings with internal adapters (neither shown) for easily swapping out the tubing. For example, the portions of the second inner tube 106 that lie outside the first outer tube 104 can be easily detached from the portions of the second inner tube 106 that lie inside the first outer tube 104 by using the interface tubes 114A and 114B that are held in place by bored-through compression fittings for easy attachment and detachment. The portions of the second inner tube 106 within the first outer tube 104 connect to the interface tubes 114A and 114B, which permits quick replacement of the portion of the second inner tube 106 that lies inside the first outer tube 104 with a new portion of second inner tubing 106 during operation.

In an example embodiment, the first outer tube 104 is manufactured from a material that has higher yield and/or rupture strength than that of the second inner tube 106. The working fluid in space 105 may be pressurized to a desired pressure. This permits the second inner tube 106 to be internally pressurized to the point of rupture (the failure strength) of the material used for the first outer tube 104. The reactants inside the second inner tube 106 can therefore be subjected to pressures that are higher than they would normally be subjected to in conventional commercial reactors. In an embodiment, the reactants inside the second inner tube 106 can be pressurized to beyond the yield strength of the material used to construct the second inner tube 106 and up to the failure strength of the first outer tube 104.

This design permits high-pressure reactions to occur without the need for specialized conventional reactors, such as glass-lined metal reactors, which are both expensive and fragile. One benefit of the reactor 100 is removing the failure strength of the second inner tube 106 as a pressure limit for the reaction. Specifically, the failure strength of the second inner tube 106 is not limiting in the reactor 100 because the working fluid can be pressurized to eliminate any pressure difference across the second inner tube 106. With no pressure difference across the second inner tube 106, there is simply no net force acting on the second inner tube 106 to cause it to rupture. At very high pressures, the walls of the second inner tube 106 may become thinner through compression, but even then, the second inner tube 106 will not fail, unlike in a conventional reactor.

In one embodiment, depending on the desired reaction pressure, both the reactor fluid (the fluid used in the second inner tube 106 with the reactants) and the working fluid may be pressurized simultaneously to eliminate the possibility of a pressure-gradient forming in either direction across the coiled tubular reactor (the second inner tube 106).

The first outer tube 104 is manufactured from a metal such as a high strength steel (steels that have yield strength levels of 550 megapascal pressure units [MPa] or higher) stainless steel, carbon steel, titanium, titanium-aluminum alloys, aluminum, or the like. It is desirable for the metals used in the first outer tube 104 to be ductile metals that do not degrade upon contact with the working fluid. Ceramics and polymers such as those listed above (for the first inner tube 102) may also be used to manufacture the first outer tube 104 for desired applications. When the first outer tube 104 and the first inner tube 102 are manufactured from a metal, this metal-encased design allows for higher reaction pressures within the second inner tube 106 for materials that traditionally could not withstand such pressures.

The second inner tube 106 (also termed the reactor tube) carries reactants that may be reacted in the reactor 100 to produce a desired product. The second inner tube 106 is typically wound around the first inner tube 102 and may or may not contact the inner tube 102 if desired. In one embodiment, the second inner tube 106 is wound around the first inner tube 102 and contacts the inner tube 102. The winding of the second inner tube 106 provides a large surface area for the reactants contained therein to exchange heat with the working fluid (in the space 105) as well as with the outer surface of the first inner tube 102. The winding may have a pitch “p” between the coils (FIG. 1) that can be varied from an outer diameter of the second inner tube 106 (in which case each coil contacts the neighboring coil) to a desired value greater than the outer diameter of the second inner tube 106 (in which case neighboring coils do not contact each other), where the appropriate heat exchange occurs (between the working fluid in space 105, the process fluid in the first inner tube 102 and the fluid/reactant in the second inner tube 106) to facilitate the reaction in the second inner tube 106. The pitch “p” may be periodic or aperiodic.

In an embodiment, the second inner tube 106 can be manufactured from a metal, a ceramic, or a polymer. Metals and ceramics (listed above) used to manufacture the first outer tube 104 and the first inner tube 102 may also be used to manufacture the second inner tube 106.

In an embodiment, the second inner tube 106 is manufactured from a flexible material that permits the tube to be wound around the first inner tube 102. Suitable flexible materials include polymers. The polymers may be inert, such that they do not react with the reactants and can withstand temperatures in the reactor 100 without any adverse consequences. The second inner tube 106 may have extremely thin walls. The second inner tube 106 maintains an inert barrier, provides heat-exchange, and guides the reaction fluid therein within the reactor 100.

Exemplary polymers include thermoplastics, thermosets, or a combination thereof. Examples of suitable polymers include polyacetals, polyacrylics, polycarbonates, polyalkyds, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, poly silazanes, polypropylenes, polyethylenes, polyethylene terephthalates, polyvinylidene fluorides, polysiloxanes, fluoropolymers, or the like, or a combination thereof.

Example polymers for use in the second inner tube 106 are elastomers. Examples of elastomers include polybutadienes, polyisoprenes, styrene-butadiene rubber, poly(styrene)-block-poly(butadiene), poly(acrylonitrile)-block-poly(styrene)-block-poly(butadiene) (ABS), polychloroprenes, epichlorohydrin rubber, polyacrylic rubber, silicone elastomers (polysiloxanes), fluorosilicone elastomers, fluoroelastomers, perfluoroelastomers, polyether block amides (PEBA), chlorosulfonated polyethylene, ethylene propylene diene rubber (EPR), ethylene-vinyl acetate elastomers, or the like, or a combination thereof.

An specific example polymer for use in the second inner tube 106 according to one embodiment is a silicone elastomer (a polysiloxane), polytetrafluoroethylene, fluoroelastomers, fluoropolymers, or a combination thereof.

In another embodiment, the second inner tube 106 may include or be a membrane that permits osmosis and may be used for permitting extractions from this inner tube while reactions occur. The membrane may be permeable or semi-permeable. When the second inner tube 106 is a membrane 106, the reactor 100 functions as a membrane reactor 100. In other words, the reactants charged to the second inner tube 106 undergo a reaction during their travel through the reactor 100, while either the permeate or the retentate is extracted from the second inner tube 106 during the reaction, thus enabling complete (e.g., one hundred percent) conversion. In this embodiment, the working fluid used in the space 105 will be a carrier sweep-fluid to enhance diffusion (osmosis) through the membrane 106 (that forms the walls of the second inner tube 106). The sweep-fluid enhances a diffusion gradient across the membrane thus facilitating increased reaction kinetics. The diffusion across the gradient may result in the removal of the desired product from the reaction environment (the second inner tube 106) thus driving the reaction to a desired equilibrium. In an embodiment, the reaction is driven to significantly higher conversions than are achievable at equilibrium. In yet another embodiment, the reaction is driven to complete conversion (e.g., one hundred percent conversion) due to the presence of the osmotic membrane as the wall for the second inner tube 106.

In an embodiment, the second inner tube 106 may include a semi-permeable membrane and be used for water filtration.

In an embodiment, the reactor 100 may be optionally covered with a layer of thermal insulation 204. The layer of thermal insulation 204 facilitates retaining a constant and uniform temperature in the reactor 100 and eliminates unintentional heat loss.

While FIG. 1 depicts a single first inner tube 102 disposed within the first outer tube 104, the reactor 100 according to an additional example embodiment may be designed with a plurality of second inner tubes 106A, 106B, . . . , etc. disposed with a single first outer tube 104. FIG. 2 depicts a schematic diagram that shows a plurality of (in this case, two) second inner tubes 106A and 106B wound around the same first inner tube 102. Individual second inner tubes 106A, 106B, etc. of the plurality of second inner tubes may contact each other at their outer diameters or, alternatively, may be spaced apart from each other. Each individual second inner tube 106A, 106B, etc. may contain the same reactants or different reactants as a neighboring individual second inner tube 106A, 106B, etc. In this configuration, the reactor 100 can produce a plurality of identical products or a variety of different products.

While the individual second inner tubes 106A, 106B, etc. shown in FIG. 2 are disposed in an sequential (parallel flow) fashion, i.e. with all of the individual second inner tubes 106A, 106B, etc. entering at the inlet port 108A and exiting at the outlet port 108B, the individual second inner tubes 106A, 106B, etc. can be arranged in an alternating fashion (for counter flow in opposite directions within respective individual second inner tubes 106A, 106B, etc. For example, the individual second inner tube 106A can be arranged to enter at outlet port 108B and exit at inlet port 108A, while the second inner tube 106B can enter at inlet port 108A and exit at inlet port 108A, or, alternatively, at a different port not shown further downstream from outlet port 108B than inlet port 108A.

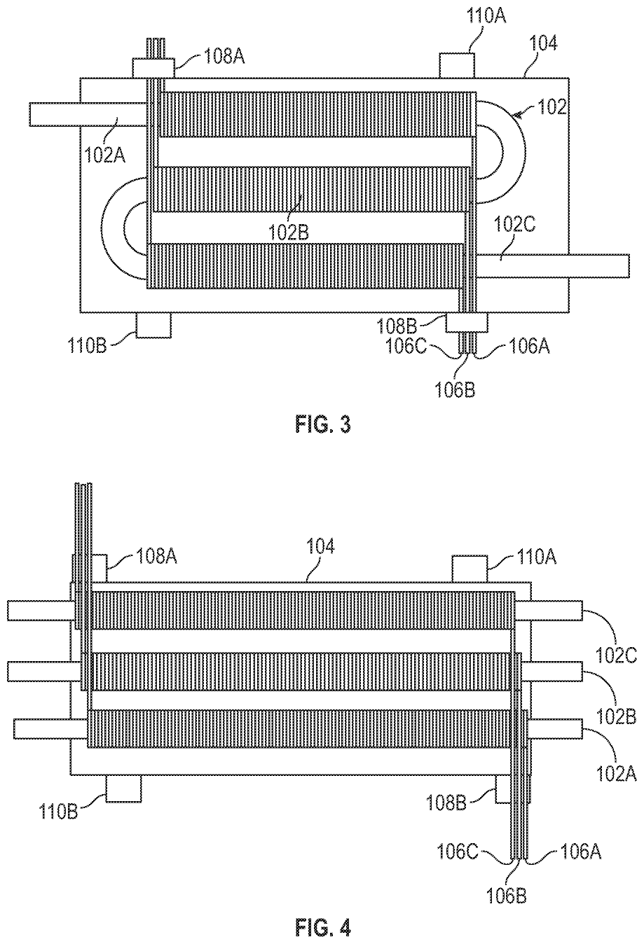

In yet another embodiment, shown in FIG. 3, the first outer tube 104 can contain a first inner tube 102 that has a plurality of individual second inner tubes 106A, 106B, and 106C disposed on the first inner tube 102. FIG. 3 depicts a top view of a single inner tube 102 that has the plurality of individual second inner tubes 106A, 106B, and 106C wrapped around it. Each of the individual second inner tubes 106A, 106B, and 106C enter the reactor 100 via inlet port 108A and exit the reactor 100 via outlet port 108B, similar as with other embodiments described above. It can be seen that the first inner tube 102 is coiled (e.g., winds, travels back and forth, and/or serpentines) in the first outer tube 104 with respective individual first inner tubes 102A, 102B and 102C of the first inner tube 102 being connected by U-shaped sections. Thus, each linear section of the first inner tube 102 has an individual second inner tube 106A, 106B, or 106C wound around it. For example, the linear section of individual inner tube 102A has the individual second inner tube 106A wound around it, while the linear section of individual first inner tube 102B has the individual second inner tube 106B wound around it, and the linear section of individual inner tube 102C has the individual second inner tube 106C wound around it, etc., though additional or alternative example embodiments are not limited thereto.

While FIG. 3 shows a single layer of the first inner tube 102, the first outer tube 104 may include a stack of first inner tubes 102 (e.g., multiple layers of first inner tubes 102) with each the linear section of each individual first inner tube 102 being surrounded by a helical second inner tube 106.

FIG. 4 depicts another embodiment of a reactor 100 that includes a first outer tube 104 containing multiple individual first inner tubes 102A, 102B, 102C, etc., with each individual first inner tube 102A, 102B, 102C, etc. being surrounded by a corresponding individual helical second inner tube 106A, 106B, 106C, etc. For example, the individual first inner tube 102A is surrounded by the individual second inner tube 106A, while the individual first inner tube 102B is surrounded by the individual second inner tube 106B and the individual first inner tube 102C is surrounded by the individual second inner tube 106C, etc. While FIG. 4 shows a single layer of the first inner tubes 102, the first outer tube 104 may include a stack of first inner tubes 102 (e.g., multiple layers of tubes) with each first inner tube 102 being surrounded by a helical second inner tube 106.

The plurality of second inner tubes 106 (e.g., the helical reactors) in the reactor 100 according to an example embodiment substantially increase efficiency and productivity of the reactor 100 by producing larger quantities of the same product, or alternatively, by producing different products. The production of different products can be conducted so long as production conditions (temperatures and pressures) are not different (or are at least sufficiently similar).

The reactor 100 may be manufactured such that it can be assembled rapidly in a modular fashion. With reference now to FIGS. 1, 2, 3, and 4 the inlet and outlet ports 108A and 108B for the second inner tube(s) 106 may include locating elements (not shown) that permit the second inner tube(s) 106 that lie outside the first outer tube 104 to be easily attached and detached from the corresponding portions of the second inner tube(s) 106 that lie inside the first outer tube 104. In a similar manner, locating elements may be used on flanges that connect the working fluid supply lines to the inlet port 110A and the outlet port 110B. The first inner tube 102 may be fitted with easily attachable and detachable parts. For example, the cartridge 112 may be inserted into the first inner tube 102 using locating elements (not shown). The locating elements permit the cartridge 112 to always be located in the same position and to consistently provide the same heating profile to the working fluid contained in the space 105.

Other heating and cooling devices (for the working fluid) may likewise be attached and detached from the reactor 100 in a modular fashion. This modular construction of the various parts of the reactor 100 simplifies both construction and the assembly of the reactor. It makes transport and maintenance easy and cost effective. Moreover, reactor downtime is minimized since the various parts can be easily removed for maintenance and then quickly reattached when maintenance is completed.

The reactor 100 can be used in a variety of different ways. It can be used as a reactor to produce a variety of different products. It can also be used as a simple heat exchanger when desired.

As described above, the reactor 100 can be used to facilitate reactions in the second inner tube 106. The reactants that are to be reacted are charged to the second inner tube 106. The working fluid is charged to the space 105 of the first outer tube 104 while the cartridge 112 is placed in the first inner tube 102. The cartridge 112 is used to heat the working fluid while a pump (not shown) may be used to pressurize the working fluid in the first outer tube 104 to a desired pressure. When the pressure and temperature of the working fluid in space 105 have reached their desired values, the reactants may be charged to the second inner tube 106 and the reaction between the reactants commences. The reactants may be continuously charged to the second inner tube 106. The length of the second inner tube 106 may be adjusted so that the reaction is completed by the time the reactants have travelled the length of the second inner tube 106. Reaction products may be continuously extracted from the second inner tube 106 at the outlet port 108B of the reactor 100.

The reactor may be operated in batch or continuous fashion as desired. This can be accomplished by changing the length of the second inner tube 106. If the residence time of the reactants in the second inner tube 106 is long (relative to the length of the second inner tube 106), the reactants can be charged periodically to the reactor with each batch being completely reacted before the next batch is charged to the reactor 100.

Alternatively, the length of the second inner tube 106 can be increased (or the rate of travel of the reactants therein can be slowed down) so that the reactants may be continuously reacted as they travel through the second inner tube 106. The reactor 100 is thus operated in a continuous fashion in this manner.

The reactor 100 may also be operated as a membrane reactor 100, as described above. In this embodiment, the second inner tube 106 is a semi-permeable membrane and the working fluid may be a sweep-fluid that facilitates a gradient in concentration between a particular reactant or product in the second inner tube 106 and its presence in the working fluid. This gradient promotes diffusion of the product from the second inner tube 106 to the working fluid through the semi-permeable membrane. The removal of the product drives the reaction to higher conversions. The working fluid (with the product contained therein) from the reactor 100 may be periodically replaced to drive the reaction in the second inner tube 106. Likewise, it can be continuously added and removed via inlet and outlet ports 110A and 110B.

In yet another embodiment, the reactor 100 may be used simply as a heat exchanger. This can be accomplished in different ways. In one embodiment, the working fluid (in the space 105) (FIG. 1) and the fluid in the first inner tube 102 may be charged to the reactor 100 (i.e. to the heat exchanger). The working fluid may be the same or different from the fluid in the first inner tube 102 but both are at the same temperature. In an exemplary embodiment, both the working fluid and the fluid in the first inner tube 102 have the same chemical composition and are at the same temperature.

A second fluid at a different temperature may be charged to the second inner tube 106. The second fluid may be heated or cooled (depending upon its temperature relative to the temperature of the working and process fluid) as it is transported through the second inner tube 106. The higher surface area of the second inner tube 106 facilitates an increase in the heat-transfer rate. When the fluids are different in chemical composition, the fluid supplied to the second inner tube 106 will actually be a third fluid. The third fluid can then be heated or cooled as desired depending upon the temperature of the working fluid and the fluid in the first inner tube 102.

In another embodiment, a cartridge 112 may be inserted into the first inner tube 102, while the working fluid in the space 105 and a second fluid in the second inner tube 106 may be heated during travel through the reactor 100. The heat transfer may be conducted in a batch or continuous process, where the rate at which the fluids (the working fluid and the second fluid) are charged to the reactor 100 may be varied depending upon the rate at which they can be heated.

The reactor 100 disclosed herein has a number of significant advantages over conventional reactors. For example, conventional reactors can only handle a relatively few types of reactants within a wide range of conditions or relatively more types of reactants within a very small range of conditions. The reactor 100 according to the embodiments described herein simultaneously accomplishes both.

The length of the reactor 100 as well as the lengths of the tubes contained therein can be changed (increased or decreased) as desired. For example, the diameters of the first outer tube 104, the first inner tube 102, and/or the second inner tube 106 can be varied depending upon the amount of heat transfer desired.

Conventional membrane reactors are often not implemented, due to the difficulties associated with constructing a tube-in-tube reactor system. However the reactor 100 shown and described herein design is a simple, flexible framework to implement membrane reactors that meet stringent pressure and temperature requirements.

Many flow-type chemistry systems have a low pressure-limit due to the pressure limit of the tubing necessary for handling high-concentration, harsh chemicals. The reactor 100 disclosed herein alleviates that problem by the use of an inert, pressurized fluid to distribute the pressure to the metal enclosure. Conventional reactors that handle wide temperature, pressure, and reactant combinations require special treatment, coatings, fabrication, and the like, which make them extremely expensive. The reactor 100 substantially improves or obviates those issues, as well.

To be thermally efficient, conventional reactors also require specialized jacket designs. The reactor 100 shown and described herein avoids that issue by leveraging pipe-insulation technology, which is extremely effective at minimizing waste heat. Moreover, by using a simple internal tube for the heat-exchange fluid, highly uniform temperatures may be achieved in the reactor 100 shown and described herein.

While the invention has been shown and described herein with reference to several non-limiting example embodiments, it will be understood by those skilled in the art that various changes may be made and equivalents may be substituted for elements thereof without departing from the spirit or scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A reactor comprising:
a first outer tube configured to contain a working fluid;
a first inner tube disposed in the first outer tube, the first inner tube configured to contain a source of heat to at least one of transfer heat to the working fluid and absorb heat from the working fluid; and
a second inner tube disposed in the first outer tube, wherein
the second inner tube is wound around the first inner tube in a helical fashion, and
the second inner tube is configured to at least one of:
absorb heat from or dissipate heat to the working fluid, and
facilitate a reaction in a reactant contained in the second inner tube.

2. The reactor of claim 1, further comprising an interface tube that isolates the second inner tube from a pressure outside of the first outer tube.

3. The reactor of claim 2, wherein
the first outer tube, the first inner tube, and the interface tube have rupture strengths that are greater than a rupture strength of the second inner tube, and
the reactant in the second inner tube can be pressurized up to the rupture strength of one of the first outer tube, the first inner tube, and the interface tube.

4. The reactor of claim 1, further comprising a heating cartridge disposed within the first inner tube, wherein the heating cartridge is configured to heat the working fluid and the second inner tube via resistive heating.

5. The reactor of claim 1, wherein the first inner tube is configured to be supplied with a process fluid that heats or cools the working fluid.

6. The reactor of claim 1, wherein the first inner tube comprises a coil that is configured to carry an alternating current to produce an eddy current in the first inner tube to heat the working fluid.

7. The reactor of claim 1, wherein at least one of the first outer tube, the first inner tube, and the second inner tube comprises one of a magnetron, a source of ultraviolet light, a source of infrared heat, an x-ray tube, and an electron beam generator.

8. The reactor of claim 1, wherein
the second inner tube is a membrane, and
the working fluid comprises a sweep-fluid that generates a gradient between a permeate concentration in the reactant in the second inner tube and a permeate concentration in the working fluid in the first inner tube resulting in permeate diffusion from the second inner tube to the working fluid.

9. The reactor of claim 8, wherein the permeate diffusion from the second inner tube drives a reaction conducted in the second inner tube resulting in higher conversion than would be achievable at equilibrium.

10. The reactor of claim 5, wherein the working fluid is the same as the process fluid.

11. The reactor of claim 5, wherein the working fluid is different from the process fluid.

12. The reactor of claim 1, further comprising a plurality of individual second inner tubes, wherein each individual second inner tube of the plurality of individual second inner tubes is wound around a linear section of the first inner tube.

13. The reactor of claim 1, further comprising a plurality of individual first inner tubes, wherein the second inner tube is wound around a linear section of each individual first inner tube of the plurality of individual first inner tubes.

14. The reactor of claim 13, further comprising a plurality of individual second inner tubes, wherein the individual second inner tubes are wound around the individual first inner tubes.

15. The reactor of claim 10, wherein
a fluid contained in the second inner tube is heated or cooled by at least one of the working fluid and the process fluid, and
the fluid contained in the second inner tube is one of the same as and different from at least one of the working fluid and the process fluid.

16. The reactor of claim 11, wherein
a fluid contained in the second inner tube is heated or cooled by at least one of the working fluid and the process fluid, and
the fluid contained in the second inner tube is one of the same as and different from at least one of the working fluid and the process fluid.

17. The reactor of claim 1, wherein at least one of the first outer tube, the first inner tube, and the second inner tube are configured to be one of attached to one another and detached from one another in a modular fashion.

18. The reactor of claim 4, wherein at least one of the first outer tube, the first inner tube, the second inner tube, and the heating cartridge are configured to be one of attached to one another and detached from one another in a modular fashion.

19. The reactor of claim 6, wherein at least one of the first outer tube, the first inner tube, the second inner tube, and the coil are configured to be one of attached to one another and detached from one another in a modular fashion.

20. A method of manufacturing a reactor, the method comprising:
disposing a first inner tube in a first outer tube, the first outer tube being configured to contain a working fluid; and
disposing a second inner tube in the first outer tube, wherein
the second inner tube is wound around the first inner tube in a helical fashion, and
the second inner tube is configured to at least one of:
a) absorb heat from or dissipate heat to the working fluid; and
b) facilitate a reaction in a reactant disposed in the second inner tube.

21. The method of claim 20 further comprising disposing a source of heat in the first inner tube, wherein the source of heat is configured to heat the working fluid in the first outer tube and the reactant in the second inner tube.

22. A method of using a reactor, the method comprising:
charging a working fluid to the reactor, wherein the reactor comprises:
a first outer tube configured to contain the working fluid;
a first inner tube disposed in the first outer tube, wherein the first inner tube comprises a source of heat configured to at least one of transfer heat to the working fluid and absorb heat from the working fluid; and
a second inner tube disposed in the first outer tube, wherein the second inner tube is wound around the first inner tube in a helical fashion; and
at least one of:
a) absorbing heat from the working fluid or dissipating heat to the working fluid; and
b) facilitating a reaction in a reactant disposed in the second inner tube.
